(19) United States
(12) Patent Application Publication
(10) Pub. No.: US 2006/0280072 A1
(43) Pub. Date: Dec. 14, 2006

(54) Optical disc recording and reproducing apparatus

(75) Inventor: Masaki Mataga, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/438,273

(22) Filed: May 23, 2006

(30) Foreign Application Priority Data
May 24, 2005 (JP) 2005-151106

(51) Int. Cl. G11B 7/12

(52) U.S. Cl. 369/47.5

(57) ABSTRACT

In a memory 23, types of a write strategy patterned into a plurality of patterns are stored. Prepit information in a land of an optical disc 25 includes a parameter of a recommended write strategy. Upon recording on the optical disc 25, a parameter of a recommended write strategy is read from the prepit information by a parameter reader 221 via an optical pickup 2. Next, based on the parameter of the recommended write strategy, a pattern determiner 222 determines the pattern of the write strategy by way of selection thereof from the memory 23. Next, based on the pattern of the write strategy and the parameter of the recommended write strategy, an optimum write strategy calculator 223 calculates an optimum write strategy. Then, based on the optimum write strategy, a laser controller 28 controls laser light of the optical pickup 2, and then recording is performed.

This application is based on Japanese Patent Application No. 2005-151106 filed on May 24, 2005, the contents of which are hereby incorporated by reference.

### BACKGROUND OF THE INVENTION

1. Field of the Invention

The present invention relates to an optical disc recording and reproducing apparatus having an optical pickup that optically performs information writing and reading an optical disc.

2. Description of the Prior Art

In recent years, as optical discs capable of recording information including mass video and audio data and the like in movies and the like, DVDs (digital versatile disks) have been widespread. Well-known DVD types include a DVD-ROM, a DVD-R, a DVD-RW, a DVD-RAM, and the like. For the DVD-ROM, information is recorded on the vender side and cannot be rewritten on the user side. For the DVD-R, writing on the user side is permitted only once. For the DVD-RW and the DVD-RAM, rewriting on the user side is permitted a plurality of times.

Optical discs, such as DVD-Rs, DVD-RWs, and the like, are each composed of: a groove part formed of grooves where information is recorded; and a land part provided between the grooves. On the land part, a write strategy recommended by a disc vender or the like are recorded. Onto these optical discs, data is recorded by combination of pits and lands.

For example, a driving current is applied from a laser driver to a laser diode of the optical pickup by a write pulse of a predetermined pulse width. The application of the driving current causes laser light emitted from the laser diode to be irradiated to the recording surface of the optical disc that rotates at a predetermined recording speed, whereby information is recorded onto the DVD-R.

In writing information onto the optical disc, laser pulse control employing a write strategy is performed. The write strategy contains information for controlling the laser pulse to be optimized at the time of recording on the optical disc. This information includes: in accordance with recording characteristics of the optical disc, information for increasing and decreasing a write pulse width and information for optimizing the timing, and the like.

Writable optical discs such as DVD-Rs and the like are supplied from various disc venders. These optical discs supplied by the different disc venders have different recording characteristics, and thus their respective suitable write strategies need to be used for writing.

In a conventional optical disc recording and reproducing apparatus, an MID (Manufacture ID) for each optical disc and data of a write strategy suitable therefor are stored in a firmware in association with each other. For the data of the write strategy, various optical disc write tests are previously performed to thereby check an optimum value for each optical disc. When the optical disc is loaded, the firmware reads the MID and controls data recording, based on the data of the write strategy associated with the read MID.

JP-A-2002-288827 and JP-A-2004-192707 disclose such an optical disc recording and reproducing apparatus. The optical disc recording and reproducing apparatus disclosed in JP-A-2002-288827 stores disc vender-specific optimum write strategies in EEPROM. Upon loading of an optical disc, the type of this optical disc is identified to read a corresponding optimum write strategy from the EEPROM, whereby the laser pulse is controlled to perform writing onto the optical disc.

The optical disc recording and reproducing apparatus disclosed in JP-A-2004-192707 is connected to a host computer via an interface. The host computer stores disc vender-specific write strategies. The write strategy stored in the host computer is transmitted to the optical disc recording and reproducing apparatus, which performs writing onto an optical disc in accordance with the received write strategy.

In the current market, even only for optical discs such as DVD-Rs and DVD-RWs, there are media having 100 MIDs or more, and the number of MIDs is expected to increase in future with increasing demand for high-speed media. However, according to the conventional optical disc recording and reproducing apparatus described above, the number of write strategies increases with increasing number of MIDs, and thus preparing a write strategy for each MID, which results in an increased capacity of write strategies. This raises a problem of an increased capacity of a memory, such as an EEPROM or the like, and the host computer and thus increased costs.

The optical disc recording and reproducing apparatus disclosed in JP-A-2004-303317 stores a standard write strategy. A recommended value of a write strategy recorded on each optical disc is read and the standard write strategy is modified to perform writing onto the optical disc. However, this method raises the need for writing onto each optical disc recommended values of a write strategy for many items.

### SUMMARY OF THE INVENTION

The present invention has been made to solve the problem described above, and it is an object of the invention to provide an optical disc recording and reproducing apparatus capable of controlling laser light without preparing a write strategy for each MID.

To achieve the object described above, according to one aspect of the invention, an optical disc recording and reproducing apparatus includes: an optical pickup for optically performing information writing and reading on an optical disc; a memory for storing types of a write strategy patterned into a plurality of patterns; parameter reader for reading a parameter of a recommended write strategy included in prepit information of the writable optical disc; pattern determiner for determining a pattern of the write strategy by way of selection thereof from the memory based on the parameter of the recommended write strategy ready by the parameter reader; optimum write strategy calculator for calculating an optimum write strategy based on the pattern of the write strategy and the parameter of the recommended write strategy; and laser controller for controlling laser light of the optical pickup at the time of recording based on the optimum write strategy.

According to this configuration, a memory stores types of a write strategy patterned into a plurality of patterns, and the prepit information in a land of the optical disc includes the parameter of the recommended write strategy. Upon recording on the optical disc, the pattern reader, parameter reader reads the parameter of the recommended write strategy included in the prepit information via the writable optical disc. Next, the determiner determines the pattern of the write strategy by way of selection thereof from the memory based on the parameter of the recommended write strategy. Subsequently, the optimum write strategy calculator calculates the optimum write strategy based on the pattern of the write strategy and the parameter of the recommended write strategy. Then, the laser controller controls the laser light of the optical pickup based on the optimum write strategy, and recording is performed.

Therefore, laser light can be controlled based on a patterned write strategy without preparing a write strategy for each MID. This reduces the capacity of write strategies occupying the firmware, thus slimming down the write strategies, which consequently requires only a small memory capacity and also permits cost reduction of the apparatus. Since the write strategy is patterned, it is required to record on the optical disc only several parameters of the recommended write strategy. Therefore, the data amount of the recommended write strategy recorded on the optical disc can be reduced.

In the optical disc recording and reproducing apparatus configured as described above, for an optical disc that permits writing only once, the parameter of the recommended write strategy includes a pulse width of laser emission of the optical pickup.

According to this configuration, the pulse width of the laser emission of the patterned write strategy is varied in accordance with the optical disc, so that recording is performed on the optical disc that permits writing only once.

In the optical disc recording and reproducing apparatus configured as described above, for an optical disc that permits writing a plurality of times, the parameter of the recommended write strategy includes a pulse width of laser emission from the optical pickup and a ratio between an erasing laser power and a recording laser power.

According to this configuration, the pulse width of the laser emission and the ratio between the erasing laser power and the recording laser power of the patterned write strategy are varied in accordance with the optical disc, and recording is performed on the optical disc that permits writing a plurality of times.

### BRIEF DESCRIPTION OF THE DRAWINGS

FIG. 1 is a block diagram showing the configuration of an optical disc recording and reproducing apparatus according to an embodiment of the present invention;

FIG. 2 is a diagram showing one example of LPP information included in the optical disc;

FIG. 3 is a diagram showing one example of a parameter of a patterned write strategy according to the embodiment of the invention;

FIG. 4 is a diagram showing one example of parameters of a patterned write strategy according to the embodiment of the invention;

FIG. 5 is a diagram of a signal waveform of a DVD-RW as an optical disc;

FIG. 6 is a diagram of signal waveforms of recorded data by mark length; and

FIG. 7 is a flowchart showing processing until start of recording performed by the optical disc recording and reproducing apparatus according to the embodiment of the invention.

### DETAILED DESCRIPTION OF THE PREFERRED EMBODIMENTS

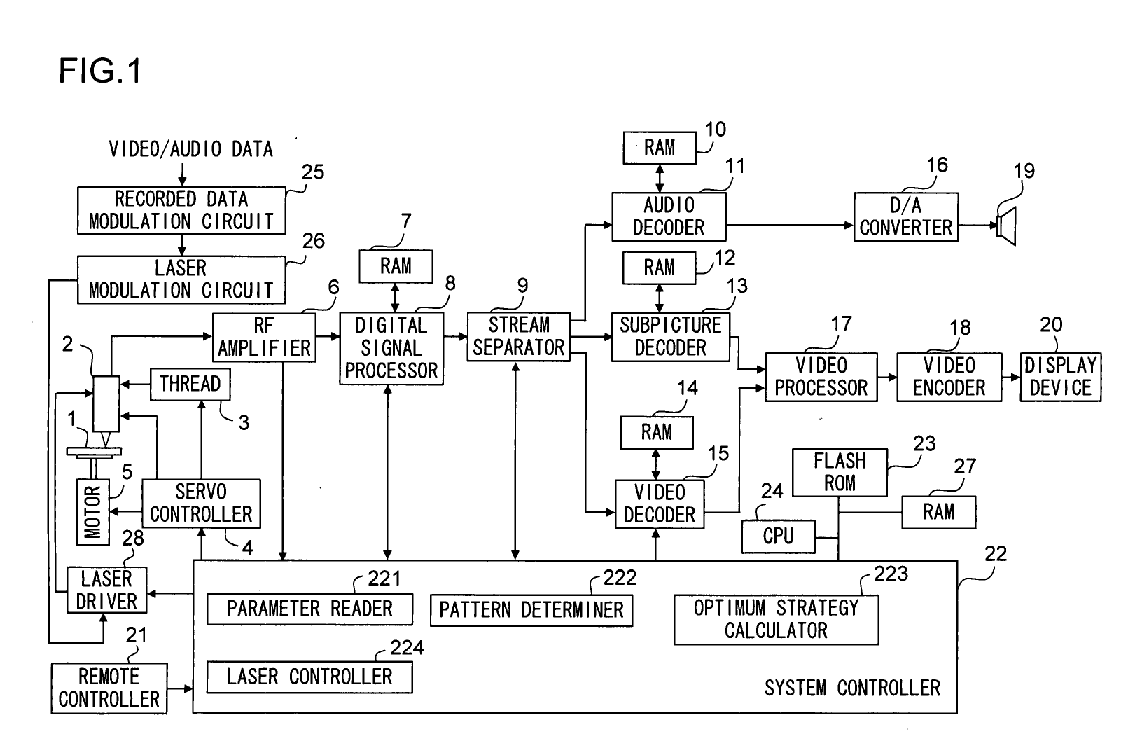

Hereinafter, an embodiment of the present invention will. be described with reference to the accompanying drawings. FIG. 1 is a block diagram showing the configuration of an optical disc recording and reproducing apparatus according to one embodiment of the present invention. The optical disc recording and reproducing apparatus includes a system controller 22 for controlling the entire apparatus, and also, a spindle motor 5, an optical pickup 2, a thread 3, a servo controller 4, and a laser driver 28.

The spindle motor 5 rotates the optical disc 1. The optical pickup 2 emits laser light for performing information recording and reproduction on the optical disc 1, and also receives reflected light from the optical disc 1. The thread 3 transfers the optical pickup 2 radially of the optical disc 1.

The servo controller 4 drives the spindle motor 5 and the thread 3 in accordance with directions given by the system controller 22. In addition, the servo controller 4 moves an objective lens (not shown) built in the optical pickup 2. This permits control of transferring the focal position of laser light in the directions perpendicular and horizontal to the recording surface of the optical disc 1. The laser driver 28 drives a laser diode (not shown) of the optical pickup 2.

The optical disc recording and reproducing apparatus also includes an RF amplifier 6, a digital signal processor 8, and a stream separator 9. The RF amplifier 6 amplifies an RF signal as a read signal from the optical pickup 2 at the time of reproduction on the optical disc 1. The digital signal processor 8 converts the RF signal outputted from the RF amplifier 6 into digital data, which is generated by performing signal demodulation processing and ECC error correction processing in accordance with the data format of the optical disc 1.

The digital data generated by the digital signal processor 8 is stored into a RAM 7. The stream separator 9 separates audio data, subpicture data, and video data from among data stream outputted from the digital signal processor 8 in accordance with directions given by the system controller 22.

The optical disc recording and reproducing apparatus also includes an audio decoder 11, a RAM 10, a subpicture decoder 13, a RAM 12, a video decoder 15, and a RAM 14. The audio decoder 11 inputs the audio data outputted from the stream separator 9 to perform predetermined decoding processing. The RAM 10 temporarily stores data for the decoding processing to be performed at the audio decoder 11.

The subpicture decoder 13 inputs the subpicture data outputted from the stream separator 9 to perform predetermined decoding processing. The RAM 12 temporarily stores data for the decoding processing to be performed at the subpicture decoder 13. The video decoder 15 inputs the video data outputted from the stream separator 9 to perform predetermined decoding processing. The RAM 14 temporality stores data for the decoding processing to be performed at the video decoder 15.

The optical disc recording and reproducing apparatus includes a video processor 17, a video encoder 18, and a D/A converter 16. The video processor 17 synthesizes data outputted from the video decoder 15 and data outputted from the subpicture decoder 13 in accordance with directions given by the system controller 22.

The video encoder 18 converts synthesized data outputted from the video processor 17 into a video signal for display so that an image is displayed on a display device 20. The D/A converter 16 converts data outputted from the audio decoder 11 into an analog audio signal and supplies it to, for example, a speaker 19.

The optical disc recording and reproducing apparatus is provided with a remote controller 21 having operation keys for giving directions to the system controller 22 by an infrared signal. The operation keys of the remote controller 21 is composed of: a power key, a reproduction key for directing reproduction, a stop key for directing stop of reproduction, a record key for directing recording, and the like.

The optical disc recording and reproducing apparatus also includes a flash ROM 23, a CPU 24, and a RAM 27. The flash ROM 23 stores programs and data for performing control of each component of the apparatus and control of the entire apparatus. The CPU 24 performs arithmetic processing in accordance with the programs and the data stored in the flash ROM 23 to control the system controller 22. The RAM 27 temporarily stores data required for processing of the CPU 24.

The optical disc recording and reproducing apparatus includes a recorded data modulation circuit 25 and a laser modulation circuit 26. The recorded data modulation circuit 25 modulates video and audio data transmitted from a TV receiver (not shown), a personal computer (not shown), or the like so as to record the data onto the optical disc 1. The laser modulation circuit 26 outputs a laser modulation signal based on the data modulated by the recorded data modulation circuit 25. Laser light emitted from the optical pickup 2 via the laser driver 28 is modulated by a laser modulation signal.

The system controller 22 of this embodiment includes parameter reader 221, pattern determiner 222, optimum write strategy calculator 223, and the laser controller 224. The parameter reader 221 reads a parameter of a recommended write strategy from prepit information in the land of the optical disc I upon recording of information onto the writable or rewritable optical disc.

The pattern determiner 222 determines a pattern of a type of a write strategy based on a parameter read from the prepit information. The optimum write strategy calculator 223 calculates an optimum write strategy based on the pattern determined by the pattern determiner 222. The laser controller 224 controls laser light of the optical pickup 5 at the time of recording based on the optimum write strategy calculated by the optimum write strategy calculator 223.

The parameter of a recommended write strategy is read from the prepit information in the land of the optical disc I by the system controller 22 with the configuration described above. Then, based on the read parameter of a recommended write strategy, a type of a write strategy is patterned. In a writable optical disc such as a DVD-R or the like, the type of a write strategy is patterned by using a pulse width of laser emission of the optical pickup 2.

In the writable optical disc such as DVD-RW or the like, using the power ratio between an erasing laser power and a recording laser power of the optical pickup 2 and the pulse width of laser emission, the type of a write strategy is patterned. Note that the parameter of a recommended write strategy only discriminates the type while a patterned write strategy is previously prepared. The patterned write strategy is stored in, for example, the flash ROM 23.

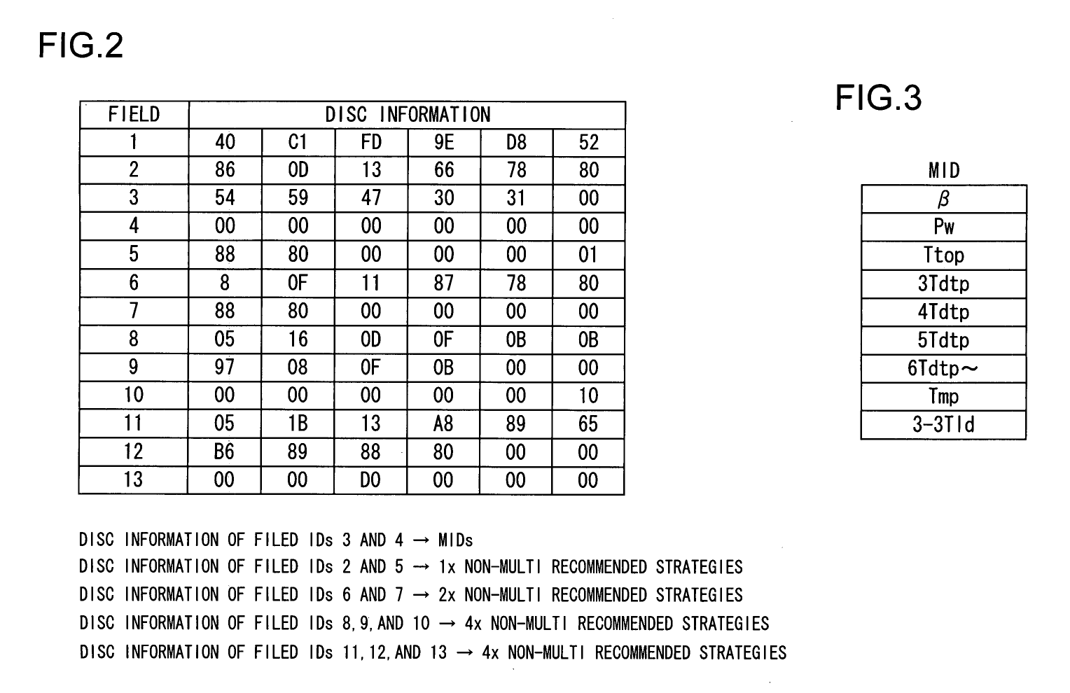

FIG. 2 is a diagram showing one example of the LPP (land prefit) information of the optical disc 1. The LPP information has disc information composed of a field ID (identifier), a recommended write strategy, and the like.

In FIG. 2, for example, the disc information of field IDs 3 and 4 indicates MIDs. The disc information of field IDs 2 and 5 indicates lx recommended write strategies. The disc information of field IDs 6 and 7 indicates 2x recommended write strategies. The disc information of field IDs 8, 9, and 10 indicates 4x non-multi recommended write strategies. Disc information of field IDs 11, 12, and 13 indicate 4x recommended write strategies.

FIG. 3 is a diagram showing one example of parameters of a patterned write strategy for an optical disc, such as a DVD-R or the like, that permits writing only once. Symbol P is a value used for OPC (laser light output control), that is, a reference value used for determining an optimum laser power of the optical pickup 2 upon recording, which is a value determined by performing test-writing on a test region of the optical disc 1.

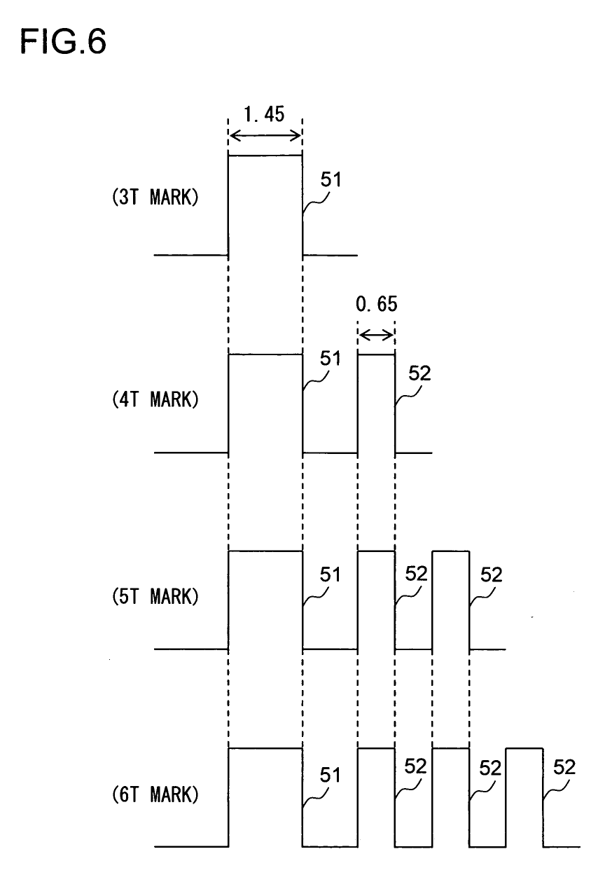

In a case where the optical disc is a DVD-R, laser light is composed of one pulse of a wide width and one or more pulses of a narrow width (see FIG. 6). The width of the leading pulse of a wide width is Ttop (leading pulse width), and the width of a multipulse of a narrow width is Tmp (multipulse width). Pw denotes a central laser power of laser powers.

In addition, when the mark length of recorded data becomes 3 T, 4 T, 5 T, 6 T or the like, the pulse width of the leading pulse is adapted to be smaller than the leading pulse width Ttop. Amounts 3 Tdtp, 4 Tdtp, 5 Tdtp, and 6 Tdtp indicate amounts by which the width of the leading pulse is reduced so as to be smaller than the leading pulse width Ttop.

The value 3 Tdtp denotes the value by which the width of the leading pulse is reduced from the leading pulse width Ttop when the mark length of the recorded data is 3 T. The value 4 Tdtp denotes a value by which the width of the leading pulse is reduced from the leading pulse width Ttop when the mark length of the recorded data is 4 T. The value 5 Tdtp denotes a value by which the width of the leading pulse is reduced from the leading pulse width Ttop when the mark length of the recorded data is 5 T. The value 6 Tdtp denotes a value by which the width of the leading pulse is reduced from the leading pulse width Ttop when the mark length of the recorded data is 6 T or more. The recorded data is composed of a mark and space in combination, and 3-3 Tld denotes a parameter that makes fine adjustments of the width of the leading pulse at 3 T mark after 3 T space.

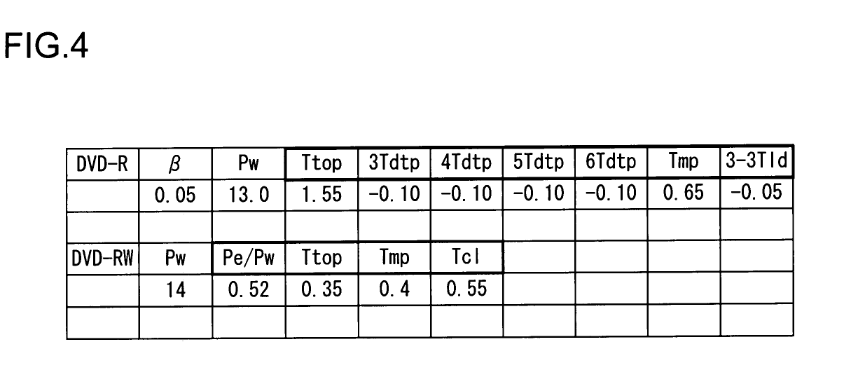

FIG. 4 is a diagram showing one example of parameters of a write strategy recommended by a disc vender which is recorded inside the LPP data, with the upper portion referring to a case where the optical disc 25 is a DVD-R, where β is “0.05”, Pw is “13.0”, Ttop is “1.55”, 3 Tdtp is “−0.10”, 4 Tdtp is “−0.10”, 5 Tdtp is “−0.10”, 6 Tdtp is “−0.10”, Tmp is “0.65”, and 3-3 Tld is “−0.05”.

FIG. 6 shows signal waveforms of recorded data in the DVD-R by mark length. When the mark length of the recorded data is 3 T, a leading pulse 51 is provided. When the mark length of the recorded data is 4 T, the leading pulse 51 and one multipulse 52 are provided. When the mark length of the recorded data is 5 T, the leading pulse 51 and two multipulses 52 are provided. When the mark length of the recorded data is 6 T, the leading pulse 51 and 3 multipulses 52 are provided. Note that IT corresponds to, for example, 37.25 ns. The pulse width of the leading pulse 51 is, for example, Ttop-3 T dtp=1.55-0.10=1.45 at 3 T mark. The pulse width of the multipulse 52 (Tmp) is equal to 0.65.

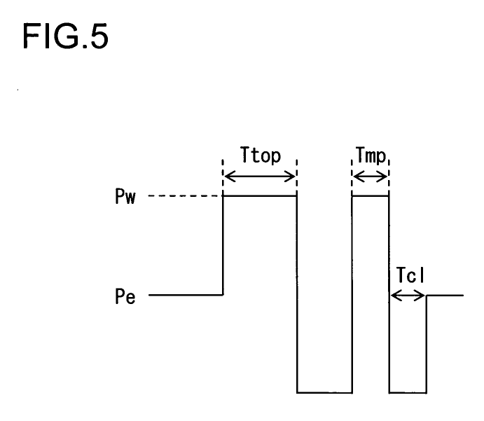

In a case of an optical disc, such as a DVD-RW or the like, that permits writing a plurality of times, as shown in FIG. 5, a signal waveform of laser light is patterned into a write strategy composed of one pulse of a wide width and one pulse of a narrow width.

Pw denotes a central laser power at the time of recording. Pe denotes a central laser power at the time of erasing. Ttop and Tmp denote, as described above, the width of the leading pulse of a wide width (leading pulse width) and the width of the multipulse of a narrow width (multipulse width). Tcl denotes a cooling pulse for cooling.

In FIG. 4 described above, the lower portion shows one example of parameters of a recommended write strategy in the case of a DVD-RW, where Pw is “14”, Pe/Pw is “0.52”, Ttop is “0.3.5”, Tmp is “0.4”, and Tcl is “0.55”. Pe/Pw denotes the ratio between a laser power at the time of recording and a laser power at the time of erasing.

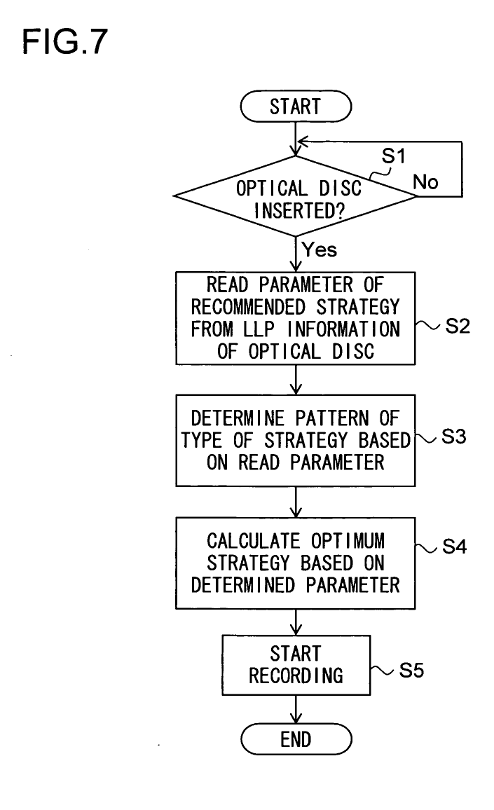

FIG. 7 is an flowchart describing processing until start of recording performed by the optical disc recording and reproducing apparatus. In step S1, the optical disc recording and reproducing apparatus stands by for the optical disc 1 to be inserted. When the user inserts the optical disc 1 in the optical disc recording and reproducing apparatus, processing proceeds to step S2. In step S2, the parameter reader 221 of the system controller 22 reads a parameter of a recommended write strategy from the LPP information of the optical disc 1.

More specifically, an RF signal is read by the optical pickup 2 from the optical disc 1 in rotation, and then inputted into the system controller 22 after being amplified by the RF amplifier. The parameter reader 221 detects the LPP information included in the RF signal to read the parameter of a recommended write strategy from the LPP information (see FIG. 2).

In step S3, based on the parameter of a recommended write strategy read by the parameter reader 221, the pattern determiner 222 determines a pattern. More specifically, the pattern of a write strategy is extracted from among one or a plurality of patterns of write strategies previously stored in the flash ROM 23 (see FIG. 3), based on the recommended write strategy. For example, a pattern for a DVD-RW or for a DVD-R is extracted.

In step S4, based on the pattern determined by the pattern determiner 222, the optimum write strategy calculator 223 calculates an optimum write strategy (see FIG. 4). More specifically, the optimum write strategy calculator 223 calculates the shape of a pulse waveform of laser light based on, for example, β“0.05”, Pw “13.0”, Ttop “1.55”, 3 Tdtp “−0.10”, 4 Tdtp “−0.10”, 5 Tdtp “−0.10”, 6 Tdtp “−0.10”, Tmp “0.65”, and 3-3 Tld “−0.05”, in the case where the optical disc 1 is the DVD-R of FIG. 4 described above.

In a case where the optical disc I is a DVD-RW, based on, for example, Pw “14”, Pe/Pw “0.52”, Ttop “0.35”, Tmp “0.4”, and Tcl “0.55”, the shape of a pulse waveform of laser light is calculated.

In step 5, information recording on the optical disc 1 starts. Consequently, the laser controller 224 of the system controller 22 drives the laser driver 28 based on the optimum write strategy calculated in step S4 to thereby control the laser light of the optical pickup 2, whereby the information is written onto the optical disc 1.

As described above, according to this embodiment, laser light can be controlled based on a patterned write strategy without preparing a write strategy for each MID. This reduces the capacity of write strategies occupying the firmware, thus slimming down the write strategies, which consequently requires only a small memory capacity and also permits cost reduction of the apparatus.

For example, for a DVD-R used as an optical disc, only 45 patterns of write strategies is required for 105 MIDs while 105 write strategies have been conventionally required for 105 MIDs. For a DVD-RW used as optical disc, only 26 patterns of write strategies are required for 35 MIDs while 35 write strategies have been conventionally required for 35 MIDs.

A write strategy is patterned, which requires recording of only several parameters of a recommended write strategy onto the optical disc 25. Therefore, the data amount of recommended write strategies recorded on the optical disc 25 can be reduced.

What is claimed is:

1. An optical disc recording and reproducing apparatus comprising:
an optical pickup for optically performing information writing and reading on an optical disc;
a memory for storing types of a write strategy patterned into a plurality of patterns;
parameter reader for reading a parameter of a recommended write strategy included in prepit information of the writable optical disc;
pattern determiner for determining a pattern of the write strategy by way of selection thereof from the memory based on the parameter of the recommended write strategy read by the parameter reader;
optimum write strategy calculator for calculating an optimum write strategy based on the pattern of the write strategy and the parameter of the recommended write strategy; and
laser controller for controlling laser light of the optical pickup at a time of recording based on the optimum write strategy.

2. The optical disc recording and reproducing apparatus according to claim 1,
wherein, for an optical disc that permits writing only once, the parameter of the recommended write strategy includes a pulse width of laser emission of the optical pickup.

3. The optical disc recording and reproducing apparatus according to claim 1,
wherein, for an optical disc that permits writing a plurality of times, the parameter of the recommended write strategy includes a pulse width of laser emission of the optical pickup and a ratio between an erasing laser power and a recording laser power.
